(19) United States
(12) Patent Application Publication
(10) Pub. No.: US 2009/0195515 A1
(43) Pub. Date: Aug. 6, 2009

(54) METHOD FOR PROVIDING UI CAPABLE OF DETECTING A PLURALITY OF FORMS OF TOUCH ON MENUS OR BACKGROUND AND MULTIMEDIA DEVICE USING THE SAME

(75) Inventor: Eun-hye LEE, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/204,214

(22) Filed: Sep. 4, 2008

(30) Foreign Application Priority Data
Feb. 4, 2008 (KR) 2008-11382

(51) Int. Cl. G06F 3/041

(52) U.S. Cl. 345/173

(57) ABSTRACT

A method of providing a user interface (UI) and a multimedia device on a touch screen, the method including: detecting a first form of touch or a second form of touch on a menu or on a background of the touch screen; and performing a first operation if the first form of touch is detected and a second operation if the second form of touch is detected. Accordingly, the user can select a diverse range of options from menus with greater ease and convenience.

### CROSS-REFERENCE TO RELATED APPLICATION

This application claims the benefit of Korean Application No. 2008-11382, filed Feb. 4, 2008, in the Korean Intellectual Property Office, the disclosure of which is incorporated herein by reference.

### BACKGROUND OF THE INVENTION

1. Field of the Invention

Aspects of the present invention relate to a method of providing a user interface (UI) and a multimedia device using the same, and more particularly, to a method of providing a UI to support a plurality of forms of touch on a touch screen and a multimedia device using the same.

2. Description of the Related Art

Multimedia apparatuses (such as MP3 players) have become widely used in recent years, and, as a result, user-friendly features such as displays on which graphical user interfaces (GUIs) are provided have been developed. GUIs generally have icons or menus that are displayed on the displays and selected using pointers. In such GUIs, the user can select and use desired content using an input unit (such as a mouse, a touch pad, or a touch screen) in order to input user commands. In particular, using a touch screen, the user can directly touch buttons on the screen to input commands, thus allowing a more intuitive use of the UI through the touch screen.

However, unlike a keyboard, a touch screen is restricted by the range of forms of touch that may be used for user inputs. In other words, in order to add a particular operation to a keyboard having a plurality of keys, a key corresponding to the operation can easily be added. However, implementing diverse operations using a touch screen is difficult since the range of forms of touch is limited.

In addition, the user may feel an inconvenience when executing operations having multiple steps. For example, in order to listen to desired music, the user may inconveniently go through the process of selected a desired genre, album, and singer categories in sequence.

Accordingly, more convenient and diverse methods of using a touch UI is desired. Therefore, there is a need for methods by which the user may select diverse menus with greater ease and convenience.

### SUMMARY OF THE INVENTION

Aspects of the present invention provide a method of providing a user interface (UI) and a multimedia device in which a plurality of forms of touch are detected on menus or background of a touch screen and an operation corresponding to each form of touch is respectively executed such that a user can select diverse menus with greater ease and convenience. Aspects of the present invention also provide a method of providing a UI and a multimedia device in which a plurality of forms of touch are detected on menus or a background of a touch screen, and if a certain form of touch is detected, an operation corresponding to the detected form of touch on the menus or background is executed or a hierarchically lower menu is displayed.

According to an aspect of the present invention, there is provided a method of providing a user interface (UI) on a touch screen, the method including: displaying a menu and a background on the touch screen; detecting a first form of touch or a second form of touch on the menu or on the background; and performing a first operation if the first form of touch is detected, and performing a second operation if the second form of touch is detected.

The first form of touch and the second form of touch may include a single touch.

The first form of touch may be a short touch and the second form of touch may be a long touch.

The first operation may display a menu of an immediately following hierarchical step to the menu, and the second operation may display a menu after at least the next two hierarchical steps to the menu.

The first operation may display a menu of an immediately following hierarchical step to the menu, and the second operation may execute an operation or display a menu of a final hierarchical step to the menu.

In performing the first operation or the second operation, if the first form of touch is detected on the background, a menu for a currently supported may be displayed, and if the second form of touch is detected on the background, a menu for selecting an image to be displayed as the background may be displayed.

In performing the first operation or the second operation, if the first form of touch is detected on a music menu, a menu for selecting a music category may be displayed, and if the second form of touch is detected on the music menu, a most recently played-back music file may be played back.

In performing the first operation or the second operation, if the first form of touch is detected on a video menu, a list of video files may be displayed, and if the second form of touch is detected on the video menu, a most recently played-back video file may be played back.

In performing the first operation or the second operation, if the first form of touch is detected on an image menu, a list of image files may be displayed, and if the second form of touch is detected on the image menu, a most recently viewed image file may be displayed.

In performing the first operation or the second operation, if the first form of touch is detected on a text menu, a list of text files may be displayed, and if the second form of touch is detected on the text menu, a most recently viewed text file may be displayed.

In performing the first operation or the second operation, if the first form of touch is detected on a back button, a hierarchically one step higher menu may be displayed, and if the second form of touch is detected on the back button, a hierarchically highest menu played-back video file may be displayed.

According to another aspect of the present invention, there is provided a multimedia device, including: a touch screen to detect a touch input by a user; and a control unit to perform a first operation if a first form of touch is detected on a menu or on a background of the touch screen, or to perform a second operation if a second form of touch is detected on the menu or on the background of the touch screen.

The first form of touch and the second form of touch may include a single touch.

The first form of touch may be a short touch and the second form of touch may be a long touch.

The first operation may display a menu of an immediately following hierarchical step to the menu, and the second operation may display a menu after at least the next two hierarchical steps to the menu.

The first operation may display a menu of an immediately following hierarchical step to the detected menu, and the second operation may execute an operation or display a menu of a final hierarchical step to the detected menu.

If the control unit detects the first form of touch on the background, a menu for a currently supported operation may be displayed, and if the control unit detects the second form of touch on the background, a menu for selecting an image to be displayed as the background may be displayed.

If the control unit detects the first form of touch on a music menu, a menu for selecting a music category may be displayed, and if the control unit detects the second form of touch on the music menu, a most recently played-back music file may be played back.

If the control unit detects the first form of touch on a video menu, a list of video files may be displayed, and if the control unit detects the second form of touch on the video menu, a most recently played-back video file may be played back.

If the control unit detects the first form of touch on an image menu, a list of image files may be displayed, and if the control unit detects the second form of touch on the image menu, a most recently viewed image file may be displayed.

If the control unit detects the first form of touch on a text menu, a list of text files may be displayed, and if the control unit detects the second form of touch on the text menu, a most recently viewed text file may be displayed.

If the control unit detects the first form of touch on a back button, a hierarchically one step higher menu may be displayed, and if the control unit detects the second form of touch on the back button, a hierarchically highest menu may be displayed.

According to yet another aspect of the present invention, there is provided a method of providing a user interface (UI) on a touch screen, the method including: displaying a menu and a background on the touch screen; detecting a form of touch on the menu or on the background; and performing an operation for entering into an execution step or displaying a menu of a final hierarchical step to the menu if the form of touch is detected.

The form of touch may be a long touch.

According to still another aspect of the present invention, there is provided a method of providing a user interface (UI) on a touch screen, the method including: displaying a menu and a background on the touch screen; detecting at least one of a plurality of forms of touch on the menu or on the background; and performing an operation corresponding to the detected form of touch.

According to another aspect of the present invention, there is provided a method of providing a user interface (UI) on a touch screen, the method including: detecting a first form of touch or a second form of touch on the touch screen; and performing a first operation if the first form of touch is detected, and performing a second operation if the second form of touch is detected.

According to another aspect of the present invention, there is provided a computer readable recording medium encoded with a method of providing a user interface on a touch screen and implemented by a computer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic block diagram illustrating a configuration of an MP3 player according to an embodiment of the present invention;

FIG. 2 is a flowchart illustrating a case in which a long touch or a short touch is detected on a background of a touch screen according to an embodiment of the present invention;

FIG. 3 is a flowchart illustrating a case in which a long touch or a short touch is detected on a music menu of a touch screen according to another embodiment of the present invention;

FIG. 4 illustrates a screen when a long touch or a short touch is detected on a background of a touch screen according to an embodiment of the present invention;

FIG. 5 illustrates a screen when a long touch or a short touch is detected on a music menu of a touch screen according to another embodiment of the present invention;

FIG. 6 illustrates a screen when a long touch or a short touch is detected on a video menu of a touch screen according to yet another embodiment of the present invention;

FIG. 7 illustrates a screen when a long touch or a short touch is detected on an image menu of a touch screen according to yet another embodiment of the present invention; and

FIG. 8 illustrates a screen when a long touch or a short touch is detected on a text menu of a touch screen according to yet another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

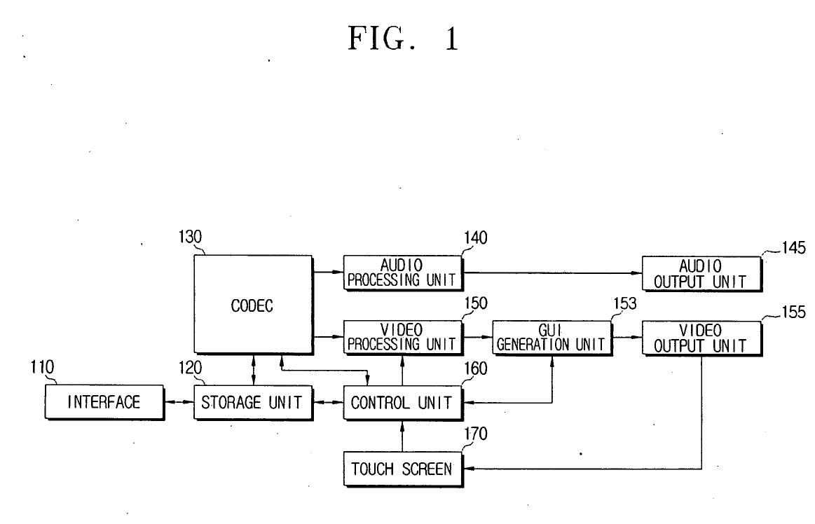

FIG. 1 is a schematic block diagram illustrating a configuration of an MP3 player according to an embodiment of the present invention. Referring to FIG. 1, the MP3 player includes an interface 110, a storage unit 120, a codec 130, an audio processing unit 140, an audio output unit 145, a video processing unit 150, a graphical user interface (GUI) generation unit 153, a video output unit 155, a control unit 160, and a touch screen 170. While FIG. 1 illustrates an MP3 player, it is understood that aspects of the present invention are not limited thereto. That is, aspects of the present invention may also be applied to a mobile phone, a personal digital assistant, a portable multimedia player, etc.

The interface unit 110 connects the MP3 player to a computer. The MP3 player downloads multimedia files (such as music files, video files, and/or text files) from the computer through the interface unit 110, and/or uploads multimedia files to the computer through the interface unit 110. The storage unit 120 stores the multimedia files and programs to operate the MP3 player.

The codec 130 compresses or decompresses the multimedia files. In detail, the codec 130 decompresses multimedia files stored in the storage unit 120, transmits audio data of the decompressed multimedia files to the audio processing unit 140, and transmits video data of the decompressed multimedia files to the video processing unit 150.

The audio processing unit 140 processes an audio signal received from the codec 130, for example, by performing sound processing, noise removal, and equalization. Subsequently, the audio processing unit 140 outputs the processed audio data to the audio output unit 145. The audio output unit 145 outputs the audio data to a speaker or an external device (such as an earphone or a headset) that is connected through an external output terminal.

The video processing unit 150 processes a video signal received from the codec 130, for example, by performing video scaling. Subsequently, the video processing unit 150 outputs the processed video data to the GUI generation unit 153. The GUI generation unit 153 generates a GUI to be displayed on a display, and displays the GUI on top of the video data output from the video processing unit 150. The video output unit 155 displays the GUI and the video output from the GUI generation unit 153 on the touch screen 170, or outputs the GUI and the video to an external device connected through an external output terminal.

The touch screen 170 displays images output from the video output unit 155, receives user commands using touch, and transmits the commands to the control unit 160. In particular, the touch screen 170 detects a short touch or a long touch on displayed menus or a background. The short touch indicates that the user touches a single point on the touch screen 170 for a time shorter than a predetermined period of time, and the long touch indicates that the user touches a single point on the touch screen 170 for a time greater than or equal to the predetermined period of time. That is, the short touch or the long touch is determined according to whether the user touches a point for a time longer than a predetermined period of time. For example, if a point is touched for less than 3 seconds, the touch may be recognized as a short touch, and if a point is touched for longer than 3 seconds, the touch may be recognized as a long touch. Moreover, the short touch or the long touch is a single touch, such that the user can feel that a single touch can result in an operation being performed (such as a change to the background of the touch screen 170 or a reproduction of music).

The control unit 160 recognizes user commands received from the touch screen 170, and controls the overall operation of the MP3 player according to the user commands. In particular, the control unit 160 detects the short touch or the long touch on the displayed menu(s) or background of the touch screen 170, and executes operations corresponding to the short touch or the long touch.

If the control unit 160 detects a short touch on the displayed menu(s) or background of the touch screen 170, the control unit 160 may cause menus immediately subsequent to the touched menu to be displayed. If the control unit 160 detects a long touch on the displayed menu(s) or background of the touch screen 170, the control unit 160 may cause menus that are two or more steps subsequent to the current step of the touched menu to be displayed. For example, if the control unit 160 detects a long touch on the menus or background of the touch screen 170, the control unit 160 may cause a desired operation to be executed or menus of a final step to be displayed.

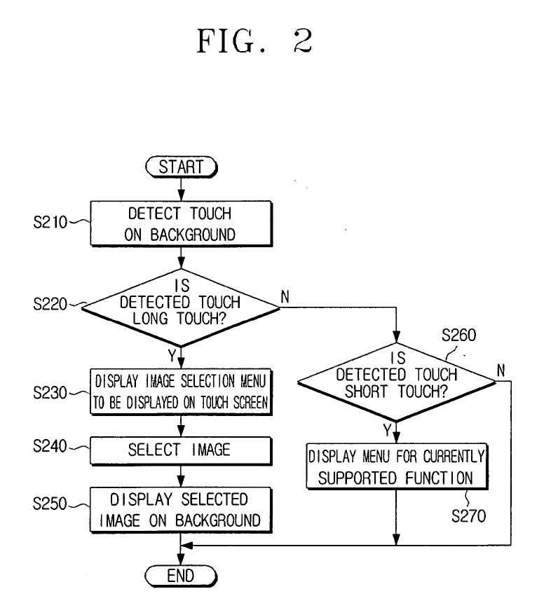

Hereinafter, the operation of the control unit 160 when the control unit 160 detects a short touch or a long touch will be described in detail. FIG. 2 is a flowchart illustrating a case in which a long touch or a short touch is detected on a background of a touch screen according to an embodiment of the present invention. Referring to FIG. 2, if the user touches the background of the touch screen 170, the touch screen 170 detects the touch in operation S210.

Subsequently, the control unit 160 determines whether the touch is a long touch in operation S220. Specifically, the control unit 160 determines whether the touch is a long touch or a short touch according to whether the background is touched for longer than a predeteremined period of time (for example, three seconds).

If the touch is a long touch (operation S220-Y), the control unit 160 controls images that can be selected as background images to be displayed on the touch screen 170 in operation S230. Subsequently, the control unit 160 receives a user command to select one of the images using the touch screen 170 in operation S240. For example, if the user performs a long touch on a desired image, the control unit 160 sets the image as a background image. The control unit 160 then controls the selected image to be displayed as a background in operation S250.

If the touch is a short touch (operation S260-Y), the control unit 160 controls menus for a currently supported operation to be displayed in operation S270.

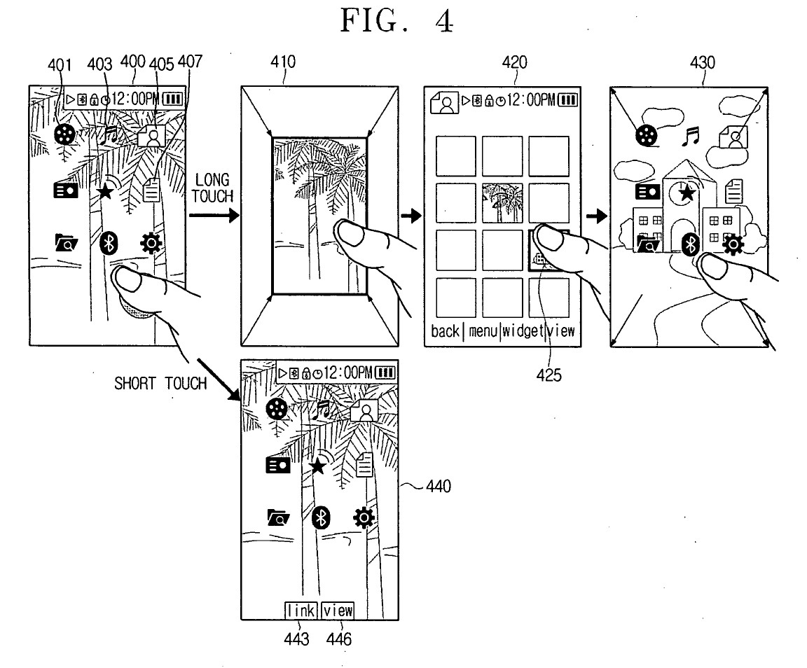

Such a method shown in FIG. 2 is described in greater detail with reference to FIG. 4, which illustrates a non-limiting case in which a long touch or a short touch is detected on the background of the touch screen 170 according to an embodiment of the present invention. Referring to FIG. 4, a main screen 400 displays a video menu 401, a music menu 403, an image menu 405, a radio menu, data communication menu, a text menu 407, a file viewer menu, a Bluetooth menu, and a setting menu on a background thereof.

If the user performs a long touch on the background, the main screen 400 changes to a first screen 410 and then a second screen 420. Specifically, all the menus disappear from the main screen 400, and the background is displayed as a thumbnail. Subsequently, as shown in the second screen 420, an image selection menu from which a background image may be selected is displayed.

According to an aspect of the present invention, the image selection menu may be displayed with animation effect in which the background is reduced. In this case, the user can intuitively recognize that the second screen 420 displays the image selection menu to select a background image.

On the second screen 420, if the user performs a long touch on a first image 425, the background changes to the first image 425, as shown in a third screen 430. As a result, the user can simply change the background image using a long touch.

Conventionally, in order to change the background image, the user selects a setting menu, selects an option to change the background, selects a desired image, and sets the desired image to be the background image. However, according to aspects of the present invention, the user can simplify this process using a long touch. If the user performs a long touch on the background of the main screen 400, operations other than the changing of a background can be implemented according to other aspects of the present invention. For example, if the user performs a long touch on the background, a different menu may be displayed.

On the main screen 400, if the user performs a short touch on the background, a link button 443 and a view button 446 are displayed as shown in a fourth screen 440. The link button 443 and the view button 446 are buttons to perform operations supported by the background.

If the user touches the link button 443, the screen may move directly to a menu linked as a favorites menu. If the user touches the view button 446, a favorites list may be displayed on the screen. That is, if the user performs a short touch on the background of the main screen 400, the control unit 160 displays buttons regarding currently supported operations. While in FIG. 4, if the user performs a short touch on the background of the main screen 400, the link button 443 and the view button 446 are displayed, it is understood that buttons other than these buttons can also be displayed. Furthermore, if the user performs a short touch on the background of the main screen 400, operations other than the displaying of buttons can be implemented according to other aspects of the present invention. For example, if the user performs a short touch on the background, a clock may be displayed.

Since different operations are performed according to whether a long touch or a short touch is performed on the background, the user can more simply use functions related to the background through diverse forms of touch.

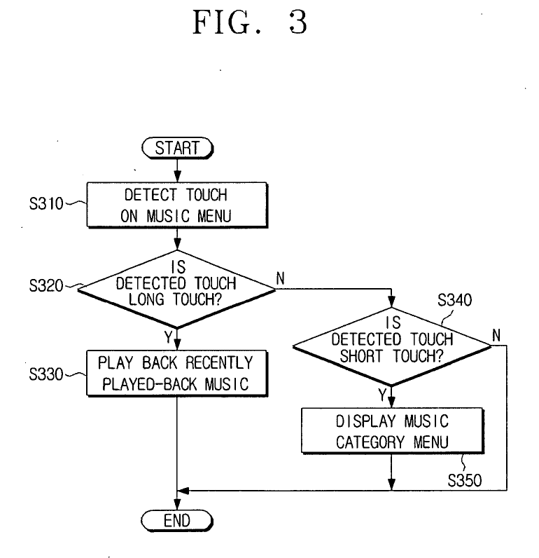

Hereinafter, the operation of the control unit 160 when a long touch or a short touch is detected on the music menu, will be described in detail with reference to FIG. 3. FIG. 3 is a flowchart illustrating a case in which a long touch or a short touch is detected on the music menu according to another embodiment of the present invention. Referring to FIGS. 3 and 4, if the user touches the music menu 403 from among the menus on the touch screen 170, the touch screen 170 detects the touch on the music menu 403 in operation S310.

Subsequently, the control unit 160 determines whether the touch is a long touch or a short touch in operation S320. In more detail, the control unit 160 determines whether the touch is a long touch or a short touch according to whether the touch lasts for a predetermined period of time (for example, for three seconds).

If the touch is a long touch (operation S320-Y), the control unit 160 controls the most recently played-back music file to be played back in operation S330. That is, a long touch on the music menu 403 plays backs the most recently played-back music file.

If the touch is a short touch (operation S340-Y), the control unit 160 controls a music category selection menu to be displayed in operation S350.

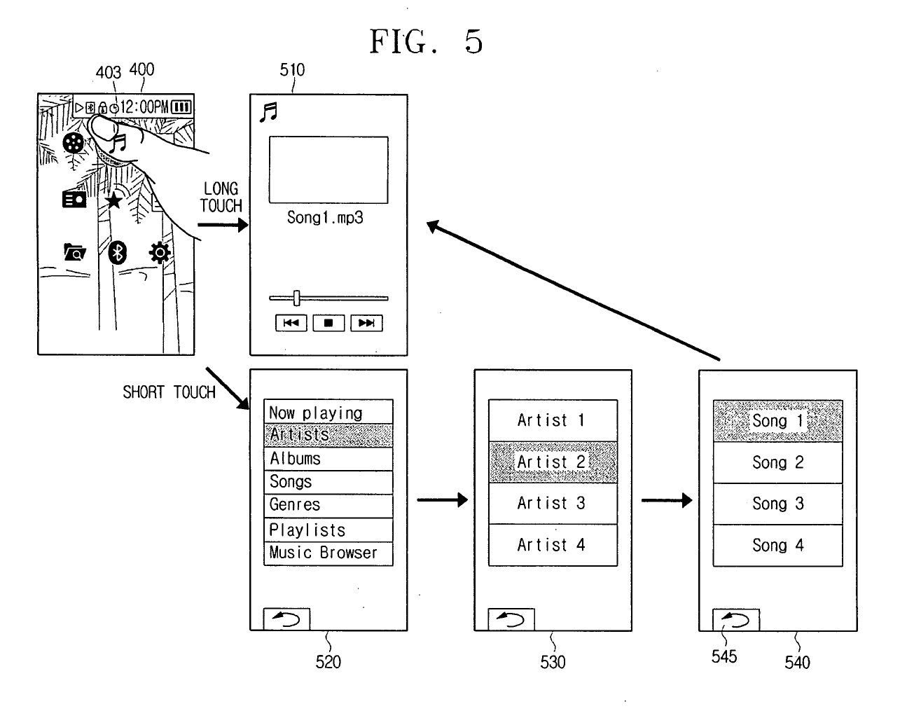

Such a process shown in FIG. 3 is described in greater detail with reference to FIG. 5, which illustrates a non-limiting case in which a long touch or a short touch is detected on the music menu of the touch screen 170 according to another embodiment of the present invention. Referring to FIG. 5, the main screen 400 is similar to that in FIG. 4. If the user performs a long touch on the music menu 403, “song1.mp3” is played back as shown in a fifth screen 510 since the user recently played back the file “song1.mp3.”

Conversely, if the user performs a short touch on the music menu 403, a music category selection menu is displayed as shown in a sixth screen 520. As shown in the sixth screen 520, the music category selection menu includes items such as “Now playing,” “Artists,” “Albums,” “Songs,” “Genres,” “Playlists,” and “Music Browser.”

If the user touches “Artists” on the sixth screen 520, the screen changes to a seventh screen 530 displaying a list of artists. If the user touches “Artist 2” on the seventh screen 530, the screen changes to an eighth screen 540 displaying a list of music belonging to “Artist 2.” If the user touches “Song 1” on the eighth screen 540, the screen changes to the fifth screen 510 playing back “song1.mp3.”

If the user performs a short touch on a back button 545 of the eighth screen 540, the seventh screen 530, which is a hierarchically higher screen, is displayed. If the user performs a long touch on the back button 545 of the eighth screen 540, the main screen 400, which is the highest screen hierarchically, is displayed.

If the user performs only a short touch, the user can listen to music through a series of operations. However, according to aspects of the present invention, if the user performs a long touch, the user can play back music directly. Therefore, the user can more conveniently listen to recently played-back music using a long touch. In addition, if the user performs only a short touch, the user can return to the main screen 400 by touching the back button 545 several times. However, according to aspects of the present invention, if the user performs a long touch, the user can return to the main screen 400 with a single long touch on the back button 545. As a result, the user can more conveniently return to the main screen 400. Moreover, the user can use two or more forms of touch to control a diverse range of operations relating to a single menu or a single button.

As described above, a long touch is applied to the background and the music menu. However, it is understood that the long touch can also be applied to other menus or operations according to other aspects of the present invention. For example, the long touch can be applied to a video menu, an image menu, and/or a text menu, as described in detail below.

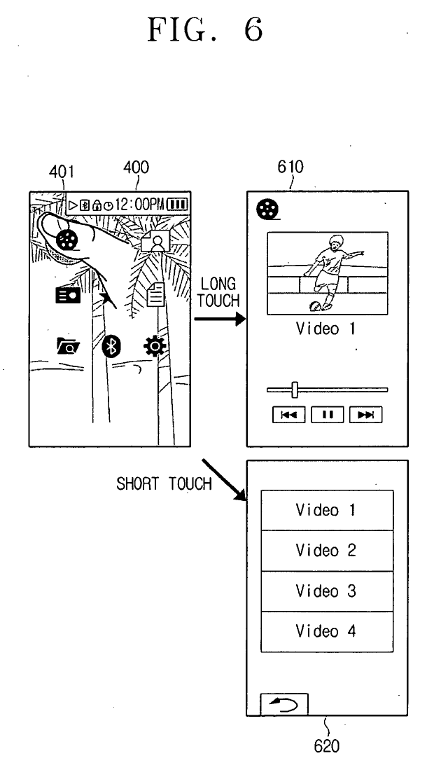

FIG. 6 illustrates a case in which a long touch or a short touch is detected on a video menu according to yet another embodiment of the present invention. Referring to FIG. 6, the main screen 400 is similar to that in FIG. 4.

If the user performs a long touch on the video menu 401 of the main screen 400, the screen changes to a ninth screen 610 on which the most recently played-back video, “video 1,” is played back. If the user performs a short touch on the video menu 401 of the main screen 400, the screen changes to a tenth screen 620 on which a list of videos is displayed.

That is, a long touch on the video menu 401 plays back a recently viewed video, and a short touch on the video menu 401 performs an immediately following operation, in which a list of videos is displayed. Therefore, the user can use two forms of touch on the video menu 401 to control a more diverse range of operations related to the video menu 401.

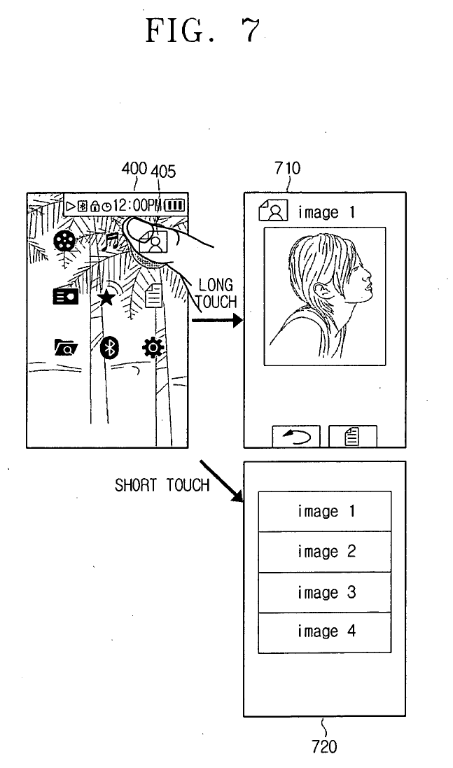

FIG. 7 illustrates a case in which a long touch or a short touch is detected on an image menu according to yet another embodiment of the present invention. Referring to FIG. 7, the main screen 400 is similar to that in FIG. 4.

If the user performs a long touch on the image menu 405 of the main screen 400, the screen changes to an eleventh screen 710 on which a recently selected image, “image 1,” is displayed. If the user performs a short touch on the image menu 405 of the main screen 400, the screen changes to a twelfth screen 720 on which a list of images is displayed.

That is, a long touch on the image menu 405 displays a recently viewed image, and a short touch on the image menu 405 performs an immediately following operation, in which a list of images is displayed. Therefore, the user can use two forms of touch on the image menu 405 to control a more diverse range of operations related to the image menu 405.

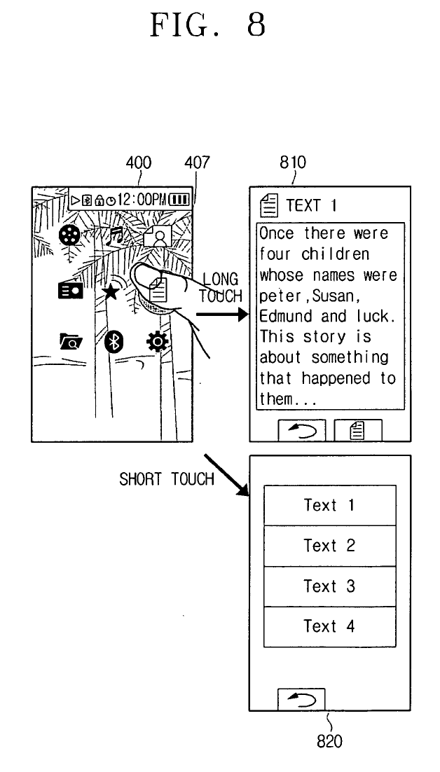

FIG. 8 illustrates a case in which a long touch or a short touch is detected on a text menu according to yet another embodiment of the present invention. Referring to FIG. 8, the main screen 400 is similar to that in FIG. 4.

If the user performs a long touch on the text menu 407 of the main screen 400, the screen changes to a thirteenth screen 810 on which a recently selected text, “Text 1,” is displayed. If the user performs a short touch on the text menu 407 of the main screen 400, the screen changes to a fourteenth screen 820 on which a list of texts is displayed.

That is, a long touch on the text menu 407 displays a recently viewed text, and a short touch on the text menu 407 performs an immediately following operation in which a list of texts is displayed. Therefore, the user can use two forms of touch on the text menu 407 to control a more diverse range of operations related to the text menu 407.

In the above embodiments of the present invention, forms of touch such as a long touch and a short touch are described. However, it is understood that in other embodiments, additional or other forms of touch (such as a double touch or a stroke) can also be applied. That is, the control unit 160 can detect more than two forms of touch on one menu.

Furthermore, in the above embodiments of the present invention, the multimedia device is an MP3 player. However, it is understood that aspects of the present invention can be applied to other multimedia devices capable of touch input (such as a portable media player (PMP), a cell phone, a laptop computer, an electronic dictionary, and a personal digital assistant (PDA)).

As described above, aspects of the present invention provide a method of controlling a UI in which a plurality of forms of touch are detected on menus and a background on a touch screen, and an operation corresponding to each form of touch is performed, and a multimedia device using the same. Accordingly, forms of touch inputs in which a user can select a diverse range of operations on menus with greater ease and convenience can be provided. For example, since the user can display the hierarchically lowest menu or execute an operation with a single long touch, the user can change a background image or play back music with minimum touch input.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of providing a user interface (UI) on a touch screen, the method comprising:
displaying a menu and a background on the touch screen;
detecting a first form of touch or a second form of touch on the menu or on the background; and
performing a first operation if the first form of touch is detected, and performing a second operation, different from the first operation, if the second form of touch is detected.

2. The method as claimed in claim 1, wherein each of the first form of touch and the second form of touch comprises a single touch.

3. The method as claimed in claim 1, wherein the first form of touch is a short touch and the second form of touch is a long touch.

4. The method as claimed in claim 1, wherein:
the first operation displays a second menu of an immediately following hierarchical step to the menu; and
the second operation displays a third menu after at least two hierarchical steps to the menu.

5. The method as claimed in claim 1, wherein:
the first operation displays a second menu of an immediately following hierarchical step to the menu; and
the second operation displays a final menu of a final hierarchical step to the menu.

6. The method as claimed in claim 1, wherein the performing of the first operation or the second operation comprises:
if the first form of touch is detected on the background, displaying a menu for a currently supported operation; and
if the second form of touch is detected on the background, displaying a menu for selecting a background image.

7. The method as claimed in claim 1, wherein the menu is a music menu and the performing of the first operation or the second operation comprises:
if the first form of touch is detected on the music menu, displaying a menu for selecting a music category; and
if the second form of touch is detected on the music menu, playing back a most recently played-back music file.

8. The method as claimed in claim 1, wherein the menu is a video menu and the performing of the first operation or the second operation comprises:
if the first form of touch is detected on the video menu, displaying a list of video files; and
if the second form of touch is detected on the video menu, playing back a most recently played-back video file.

9. The method as claimed in claim 1, wherein the menu is an image menu and the performing of the first operation or the second operation comprises:
if the first form of touch is detected on the image menu, displaying a list of image files; and
if the second form of touch is detected on the image menu, displaying a most recently viewed image file.

10. The method as claimed in claim 1, wherein the menu is a text menu and the performing of the first operation or the second operation comprises:
if the first form of touch is detected on the text menu, displaying a list of text files; and
if the second form of touch is detected on the text menu, displaying a most recently viewed text file.

11. The method as claimed in claim 1, further comprising:
displaying a back button on the touch screen,
wherein the performing of the first operation or the second operation comprises:
if the first form of touch is detected on the back button, displaying a hierarchically one step higher menu; and
if the second form of touch is detected on the back button, displaying a hierarchically highest menu.

12. The method as claimed in claim 1, wherein the performing of the first operation or the second operation comprises:
performing the first operation if the first form of touch is detected on the menu;
performing the second operation if the second form of touch is detected on the menu;
performing a third operation, different from the first operation and the second operation, if the first form of touch is detected on the background; and
performing a fourth operation, different from the first operation, the second operation, and the third operation, if the second form of touch is detected on the background.

13. The method as claimed in claim 1, wherein the second operation displays a second menu, different from the menu, that is not an immediately following hierarchical step to the menu.

14. The method as claimed in claim 1, wherein the second operation displays a menu for selecting a background image.

15. The method as claimed in claim 14, wherein the performing of the first operation or the second operation comprises executing an animation effect in which the background is reduced before the menu for selecting the background image is displayed if the second form of touch is detected.

16. The method as claimed in claim 1, wherein the first operation loads a most-recently loaded file.

17. A multimedia device providing a user interface, the multimedia device comprising:
a touch screen to receive a form of touch input by a user; and
a control unit to perform a first operation if a first form of touch is detected on the touch screen, or to perform a second operation, different from the first operation, if a second form of touch is detected on the touch screen.

18. The device as claimed in claim 17, wherein the control unit performs the first operation if the first form of touch is detected on a menu or a background of the touch screen, or performs the second operation if the second form of touch is detected on the menu or the background of the touch screen.

19. The device as claimed in claim 17, wherein each of the first form of touch and the second form of touch comprises a single touch.

20. The device as claimed in claim 17, wherein the first form of touch is a short touch and the second form of touch is a long touch.

21. The device as claimed in claim 18, wherein:
the first operation displays a second menu of an immediately following hierarchical step to the menu; and
the second operation displays a third menu after at least two hierarchical steps to the menu.

22. The device as claimed in claim 18, wherein:
the first operation displays a second menu of an immediately following hierarchical step to the menu; and
the second operation displays a final menu of a final hierarchical step to the menu.

23. The device as claimed in claim 18, wherein:
if the control unit detects the first form of touch on the background, a menu for a currently supported operation is displayed; and
if the control unit detects the second form of touch on the background, a menu for selecting a background image is displayed.

24. The device as claimed in claim 18, wherein:
the menu is a music menu;
if the control unit detects the first form of touch on the music menu, a menu for selecting a music category is displayed; and
if the control unit detects the second form of touch on the music menu, a most recently played-back music file is played back.

25. The device as claimed in claim 18, wherein:
the menu is a video menu;
if the control unit detects the first form of touch on the video menu, a list of video files is displayed; and
if the control unit detects the second form of touch on the video menu, a most recently played-back video file is played back.

26. The device as claimed in claim 18, wherein:
the menu is an image menu;
if the control unit detects the first form of touch on the image menu, a list of image files is displayed; and
if the control unit detects the second form of touch on the image menu, a most recently viewed image file is displayed.

27. The device as claimed in claim 18, wherein:
the menu is a text menu;
if the control unit detects the first form of touch on the text menu, a list of text files is displayed; and
if the control unit detects the second form of touch on the text menu, a most recently viewed text file is displayed.

28. The device as claimed in claim 17, wherein:
the control unit performs the first operation if the first form of touch is detected on a back button of the touch screen, or performs the second operation if the second form of touch is detected on the back button of the touch screen;
if the control unit detects the first form of touch on the back button, a hierarchically one step higher menu is displayed; and
if the control unit detects the second form of touch on the back button, a hierarchically highest menu played-back video file is displayed.

29. The device as claimed in claim 18, wherein the control unit:
performs the first operation if the first form of touch is detected on the menu;
performs the second operation if the second form of touch is detected on the menu;
performs a third operation, different from the first operation and the second operation, if the first form of touch is detected on the background; and
performs a fourth operation, different from the first operation, the second operation, and the third operation, if the second form of touch is detected on the background.

30. A method of providing a user interface (UI) on a touch screen, the method comprising:
displaying a menu and a background on the touch screen;
detecting whether a predetermined form of touch, from among a plurality of different forms of touch, is on the menu or on the background; and
performing a predetermined operation if the predetermined form of touch is detected,
wherein the predetermined operation enters into an execution operation or displays a final menu of a final hierarchical step to the menu.

31. The method as claimed in claim 30, wherein the predetermined form of touch is a long touch.

32. The method as claimed in claim 30, wherein the execution operation plays back a most-recently played back multimedia file.

33. A method of providing a user interface (UI) on a touch screen, the method comprising:
displaying a menu and a background on the touch screen;
detecting one of a plurality of forms of touch on the menu or on the background; and
performing an operation corresponding to the detected form of touch.

34. A method of providing a user interface (UI) on a touch screen, the method comprising:
detecting a first form of touch or a second form of touch on the touch screen; and
performing a first operation if the first form of touch is detected, and performing a second operation, different from the first operation, if the second form of touch is detected.

35. The method as claimed in claim 34, further comprising:
determining whether the first form of touch or the second form is on a predetermined region of the touch screen,
wherein the performing of the first operation or the second operation comprises:
performing the first operation or the second operation if the first form of touch or the second form of touch is determined to be on the predetermined region of the touch screen, and
not performing the first operation or the second operation if the first form of touch or the second form of touch is determined to not be on the predetermined region of the touch screen.

36. The method as claimed in claim 34, further comprising:
determining whether the first form of touch or the second form is on a first region of the touch screen or a second region of the touch screen,
wherein the performing of the first operation or the second operation comprises:
performing the first operation if the first form of touch is detected on the first region,
performing the second operation if the second form of touch is detected on the first region,
performing a third operation, different from the first operation and the second operation, if the first form of touch is detected on the second region, and
performing a fourth operation, different from the first operation, the second operation, and a third operation, if the second form of touch is detected on the second region.

37. A computer readable recording medium encoded with the method of claim 1 and implemented by a computer.

38. A computer readable recording medium encoded with the method of claim 30 and implemented by a computer.

39. A computer readable recording medium encoded with the method of claim 33 and implemented by a computer.

40. A computer readable recording medium encoded with the method of claim 34 and implemented by a computer.
